(19) United States
(12) Patent Application Publication
(10) Pub. No.: US 2015/0153508 A1
(43) Pub. Date: Jun. 4, 2015

(54) LIGHT SOURCE DEVICE AND DISPLAY DEVICE

(71) Applicants: Kabushiki Kaisha Toshiba, Tokyo (JP); Toshiba Lifestyle Products & Services Corporation, Tokyo (JP)

(72) Inventors: Hisayuki MIHARA, Kodama (JP); Harumi TANABE, Tokyo (JP); Hirofumi SAKURAI, Kumagaya (JP)

(21) Appl. No.: 14/473,887

(22) Filed: Aug. 29, 2014

(30) Foreign Application Priority Data
Nov. 29, 2013 (JP) 2013-247769

(51) Int. Cl. F21V 8/00; G02F 1/1335

(52) U.S. Cl. CPC G02B 6/0096; G02B 6/0003; G02B 6/0073; G02B 6/0026; G02F 1/133524; G02F 1/133603

(57) ABSTRACT

One embodiment provides a light source device 10 that efficiently emits a light. The light source device 10 comprises a light-emitting element 12 that emits an excited light having a wavelength shorter than that of a blue light and a rod 14 having a light-converting member 13 enclosed inside and emitting a white light from an outgoing part 14ₒᵤₜ, the light-converting member 13 converting the excited light that enters through an incident part 14ᵢₙ into a long-wavelength light having a longer wavelength, and the incident part 14ᵢₙ is covered with a dichroic coat 17 that transmits the excited light and reflects the long-wavelength light.

### CROSS-REFERENCE TO RELATED APPLICATION(S)

The application is based upon and claims the benefit of priority from Japanese Patent Application No. 2013-247769 filed on Nov. 29, 2013, the entire contents of which are incorporated herein by reference.

### FIELD

The embodiment of the present invention relates to a light source device emitting a light with converting an excited light emitted from a light-emitting element into a white light and a display device comprising the light source device.

### BACKGROUND

There has been investigated, as a backlight unit of a liquid crystal display device, an edge-light type light source device where an excited light generated by a light-emitting diode is converted into a white light by a quantum dot and then emitted to a light guide plate.

However, a light generated by the quantum dot has no directionality and is emitted in all directions. Therefore, there is a concern that the light emitted in directions other than the direction toward the light guide plate is not effectively utilized. Moreover, a part of the light emitted to directions other than the direction toward the light guide plate enters the light guide plate after reflection is repeated a number of times but a short-wavelength light is much attenuated as compared with a long-wavelength light owing to multiple reflection and the like, so that there is a concern that color temperature is lowered and color rendering properties are deteriorated.

An object of the embodiment of the present invention is to provide a light source device effectively emitting a light and a display device comprising the light source device.

### BRIEF DESCRIPTION OF DRAWINGS

FIG. 1A is a front cross-sectional view of a display device of first embodiment.

FIG. 1B is a cross-sectional view of a display device of first embodiment along the 1B-1B line in FIG. 1.

FIG. 2 is a cross-sectional view of a light source device of first embodiment.

FIG. 3 is a drawing showing spectra of an excited light and long-wavelength lights in a light source device of first embodiment and transmission/reflection properties of a dichroic coat.

FIG. 4 is a cross-sectional view of a light source device of a modified example of first embodiment.

FIG. 5 is a cross-sectional view of a light source device of second embodiment.

FIG. 6 is a cross-sectional view showing a light path of a light source device of second embodiment.

FIG. 7 is a cross-sectional view of a light source device of third embodiment.

FIG. 8 is a cross-sectional view showing a light path of a light source device of third embodiment.

### DETAILED DESCRIPTION

A light source device of one embodiment of the invention is a light source device comprising a light-emitting element that emits an excited light having a wavelength shorter than that of a blue light and a rod having a light-converting member enclosed inside and emitting a white light from an outgoing part, the light-converting member converting the excited light that enters through an incident part into a long-wavelength light having a longer wavelength, wherein the incident part is covered with a dichroic coat that transmits the excited light and reflects the long-wavelength light.

Embodiments will be hereinafter described.

### First Embodiment

### Constitution of Display Device

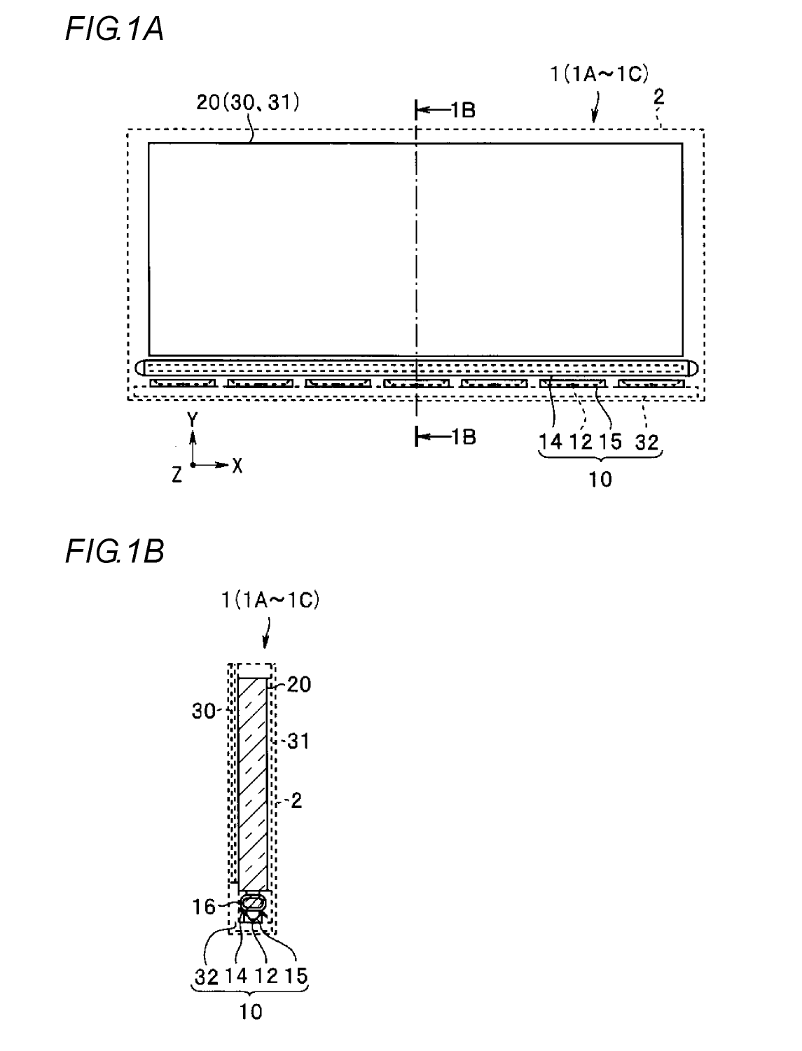

As shown in FIG. 1A and FIG. 1B, the display device 1 of first embodiment of the invention comprises a case 2, a light source device 10, a light guide plate 20, a liquid crystal display part 30, an optical sheet 31, and a wiring board 32. FIG. 1B is a cross-sectional view (YZ plane) along the 1B-1B line in FIG. 1. Incidentally, the case 2, the optical sheet 31, the liquid crystal display part 30, the wiring board 32, and the like are represented by broken lines and the display device 1 comprises other constitutional elements not shown in the figure. Moreover, the drawing is a schematic view and the size and the like of the constitutional elements are deformed in some cases in order to make explanation facile.

The light guide plate 20 is a thin transparent member composed of a PMMA-based or styrene-based resin or the like. A light that is generated by the light source device 10 and enters through a lower end surface of the light guide plate 20 is emitted toward the liquid crystal display part 30 disposed on the main surface side while reflection is repeated inside. On the rear side of the light guide plate 20, the optical sheet 31 is provided. The optical sheet 31 homogeneously irradiates the liquid crystal display part 30 with controlling and/or diffusing the emission direction of the light emitted from the light guide plate 20.

The liquid crystal display part 30 is a flat transmission-type liquid crystal panel whose outer shape is almost rectangular. In the liquid crystal display part 30, a liquid crystal in which arrangement is changed by an electric field is filled between at least two sheets of a substrate composed of glass or the like.

### Constitution of Light Source Device

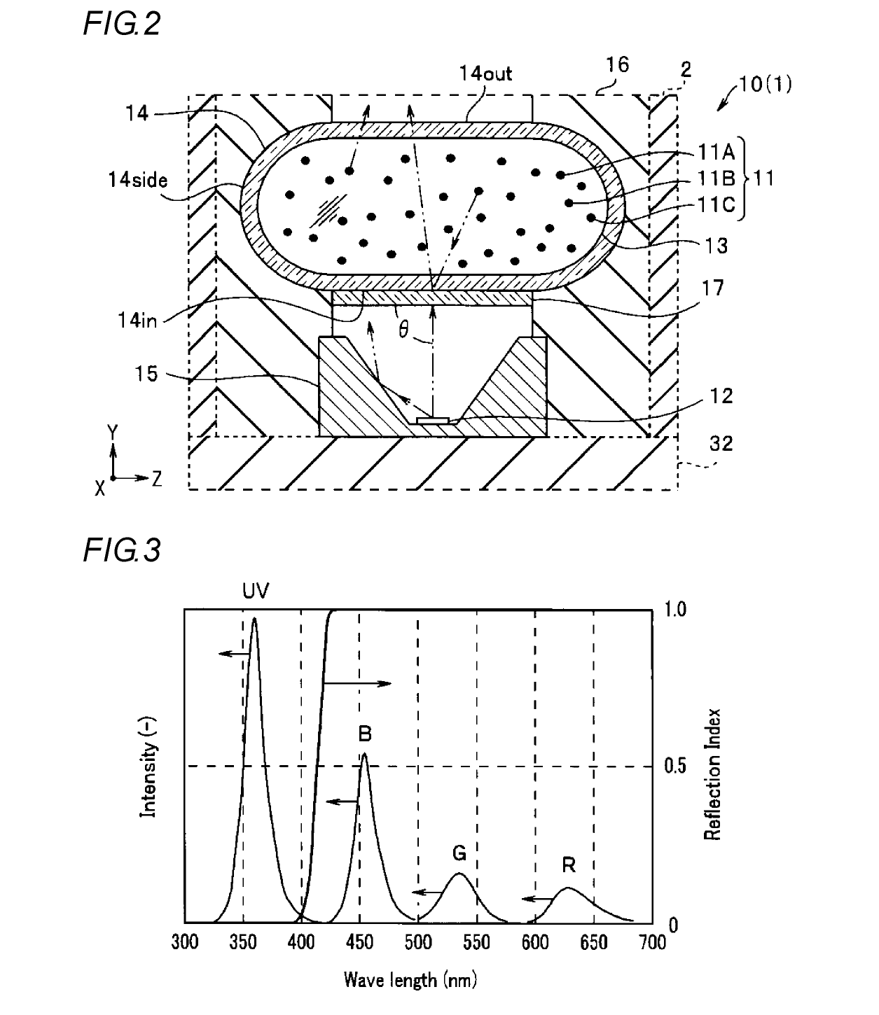

FIG. 2 is a partial enlarged view of FIG. 1B, that is, a cross-sectional view (YZ plane) of a rod 14 in a short-axis direction, the light source device 10 being centered.

As shown in FIG. 2, the light source device 10 comprises plural reflection parts 15 and plural light-emitting elements 12 disposed on the wiring board 32, a rod 14 where a light-converting member 13 is enclosed inside, and a white member 16. Incidentally, as mentioned later, the white member 16 is not an essential constitutional element.

The light-emitting element 12 generates an excited light having a wavelength shorter than that of a blue light (e.g., a wavelength of 435.8 nm). That is, the excited light is a near-ultraviolet light or an ultraviolet light. The light-emitting element 12 is, for example, selected from light-emitting diodes (LED), organic EL elements, inorganic EL elements, laser diodes, and the like but, from the standpoints of light generation efficiency and the like, a light-emitting diode composed of a gallium nitride-based compound semiconductor is particularly preferred. The size of the light-emitting element 12 is, for example, an outer shape having a length of about 6 mm and a width of about 3 mm.

For the wiring board 32, a rigid board composed of a high thermal conductivity material such as alumina or a flexible wiring board is used. Plural reflection parts 15 and plural light-emitting elements 12 are disposed on the wiring board 32 at intervals of several millimeters to several centimeters. Incidentally, the reflection part 15 will be mentioned later in detail.

The rod 14 is, for example, a long and narrow hollow tube composed of a transparent material such as glass. As shown in FIG. 2, the rod 14 is one whose cross-section in a short-axis direction is a track shape. Here, the track shape is a shape similar to a track of athletics in which opposed two sides of a rectangle in a short-axis direction are replaced by curves such as arcs.

Namely, an incident part 14ᵢₙ from which the excited light enters and an outgoing part 14ₒᵤₜ opposing the incident part 14ᵢₙ, from which the white light outgoes, are composed of parallel surfaces and the side part 14_{side} is composed of a curved surface.

Incidentally, the cross-sectional shape of the rod 14 may be an ellipse, a circle, or a shape combining parts of arcs of an ellipse or a circle and the like. Moreover, the rod 14 has a constant thickness and the shape of the hollow part in which the light-converting member 13 is enclosed is about the same as the outer peripheral shape of the rod 14 but may be different from the shape.

As shown in FIG. 3, the light-converting member 13 converts the excited light UV into three kinds of long-wavelength lights each having a longer wavelength (blue light B, green light G, red light R) and emits a white light in which three kinds of the lights are mixed. Incidentally, the spectra of the long-wavelength lights shown in FIG. 3 are shown as one example and the light-emitting element 12 and the light-converting member 13 are selected so that a white light having a desired specification is emitted.

Incidentally, as compared with a light source device that uses the blue light B as an excited light and generates the green light G and the red light R by the light-converting member 13, the light source device 10 that uses an excited light having a wavelength shorter than the blue light B exhibits better color rendering properties.

The light-converting member 13 of the embodiment is composed of a solution, a resin, or the like containing three kinds of quantum dots 11 (11A, 11B, and 11C) dispersed therein. The quantum dot (QD: Quantum Dot) 14 is a nanoscale semiconductor crystal having a particular optical property according to quantum mechanics. For example, the quantum dot 11 is constituted by 10 to 50 pieces of atoms and has a diameter of 2 nm to 10 nm.

The quantum dot 11 contains a core nanocrystal containing at least one of a Group II compound semiconductor, a Group III compound semiconductor, a Group V compound semiconductor, and a Group VI compound semiconductor or a shell nanocrystal surrounding the core nanocrystal. Moreover, the quantum dot 11 may contain an organic ligand to be bonded to the shell nanocrystal or an organic coating layer surrounding the shell nanocrystal. The quantum dot 11 is, for example, synthesized by a wet chemical etching method where a precursor substance is charged into an organic solvent and particles are grown.

When receiving an excited light, the quantum dot 11 converts the light into a long-wavelength light having a longer wavelength according to a band gap. The band gap can be controlled by the size (particle diameter), composition, and structure of the crystal. The quantum dots 11A, 11B, and 11C convert the excited light into the red light R, the green light G, and the blue light B, respectively. Incidentally, the concentration (quantity) of the quantum dots 11A, 11B, and 11C contained in the light-converting member 13 is appropriately determined depending on the specification and the like of the white light to be emitted. Moreover, the light-converting member 13 may contain two kinds or four or more kinds of quantum dots 11.

Since the quantum dot 11 has a narrow half-value width of an emission spectrum, an extinction coefficient larger by 100 to 1,000 times, and a high quantum yield as compared with conventional fluorescent materials, a generated light (fluorescence) exhibits high brightness and has a long life.

Incidentally, as the light-converting member 13, a conventional fluorescent material such as an organic phosphor, a YAG (yttrium-aluminum-garnet)-based phosphor, a TAG (terbium-aluminum-garnet)-based phosphor, or the like may be used.

As shown in FIG. 3, in the light source device 10, the incident part 14ᵢₙ of the rod 14 is covered with a dichroic coat 17 that transmits the excited light generated by the light-emitting element 12 and reflects the long-wavelength light generated by the quantum dot 11. Namely, a reflection characteristic of the dichroic coat 17 is shown in FIG. 3. Since the dichroic coat 17 does not absorb a light, transmission becomes 1 (transmittance: 100%) in the case when reflection is 0 (reflectance: 0%).

The dichroic coat 17 is an optical filter constituted by laminating plural kinds of thin films composed of transparent dielectric materials different in refractive index and reflects or transmits a light having a specific wavelength range utilizing light interference. As the dielectric material, for example, SiO₂ (refractive index: n=about 1.5), LaF₃ (n=about 1.58), Al₂O₃ (n=about 1.62), a composite oxide of Pr₂O₃ and Al₂O₃ or a composite oxide of La₂O₃ and Al₂O₃ (n=about 1.65 to 1.8), Bi₂O₃ (n=about 1.9), SiO (n=about 1.97), Ta₂O₅ (n=about 2.0), TiO₂ (n=about 2.1 to 2.5), Nb₂O₅ (n=about 2.1 to 2.4), or the like can be used.

For example, the dichroic coat 17 is a dielectric multilayered film in which a titanium oxide layer having a refractive index of 2.4 and a silicon oxide layer having a refractive index of 1.5 are laminated into a multilayer. By controlling the thickness of each layer, the number of laminated layers, and the like, a desired reflective characteristic (transmission characteristic) as shown in FIG. 3 can be obtained.

The dichroic coat 17 transmits a near ultraviolet light or an untraviolet light having a short wavelength and reflects long-wavelength lights (blue light B, green light G, and red light R).

Incidentally, the side part 14_{side} of the rod 14 is covered with a white member 16 that reflects a light. Instead of the white member 16, the side part 14_{side} may be covered with the dichroic coat 17 or a metal film. Namely, not only the incident part 14ᵢₙ but also the side part 14_{side} may be covered with the dichroic coat 17.

Since the light source device having no white member 16 not only reduces costs but also does not require mold development for producing the white member, a development time can be shortened. Moreover, much more holding members can be disposed or a larger space for heat radiation can be secured in the periphery of the rod.

On the other hand, the reflection part 15 is a light path-converting member that reflects the excited light generated by the light-emitting element 12 so that the direction of the excited light comes close to a vertical direction toward the incident part 14ᵢₙ. The reflection part 15 may sufficiently have a high reflectance at least at the surface through which the excited light enters.

Here, the characteristic (transmission/reflection) of the dichroic coat 17 changes depending on the incident direction of a light. Moreover, wavelength dependency also changes depending on the incident direction of a light. In general, the dichroic coat 17 is designed on the basis of a vertically entering ray of light (incident angel θ=90 degrees) or a main ray of light. In the dichroic coat designed on the basis of the vertical incident ray of light, a part of the excited light entering at an angle (e.g., 30 degrees or less or 150 degrees or more) apart from a vertical direction (incident angel θ=90 degrees) is reflected.

However, as shown in FIG. 2, in the light source device 10, of the excited light generated by the light-emitting element 12, a light emitted at an angle apart from a vertical direction toward the dichroic coat 17 is reflected by the reflection part 15 and enters the dichroic coat 17 at an angle close to a vertical direction.

Incidentally, FIG. 2 is a cross-sectional view in a short-axis direction but the reflection part 15 may have a reflection surface that reflects the excited light so that the direction of the excited light comes close to a vertical direction toward the incident part 14ᵢₙ, also in a long-axis direction. Moreover, by shortening a disposal interval of the light-emitting element 12, the incident angle θ can be set to an angle close to a vertical direction.

Namely, the reflection part 15 is not an essential constitutional element but, since the incident angle of the entering excited light does not largely depart from 90 degrees in the case of the dichroic coat 17 of the light source device 10 having the reflection part 15, the dichroic coat 17 can transmit the excited light without reflection and particularly, the excited light can efficiently enter the light-converting member 13.

As already explained, in the conventional light source device where the incident part is not covered with the dichroic coat 17, the quantum dot 11 is generated and the long-wavelength light emitted toward the incident part 14ᵢₙ side enters the reflection part 15, thus repeating multiple reflection. On the other hand, in the light source device 10, the long-wavelength light emitted toward the incident part 14ᵢₙ side is reflected by the dichroic coat 17 and is guided to the outgoing part 14ₒᵤₜ side.

Therefore, the light source device 10 can efficiently emit a light and thus the display device 1 comprising the light source device 10 can easily obtain a bright display picture.

### Modified Example of First Embodiment

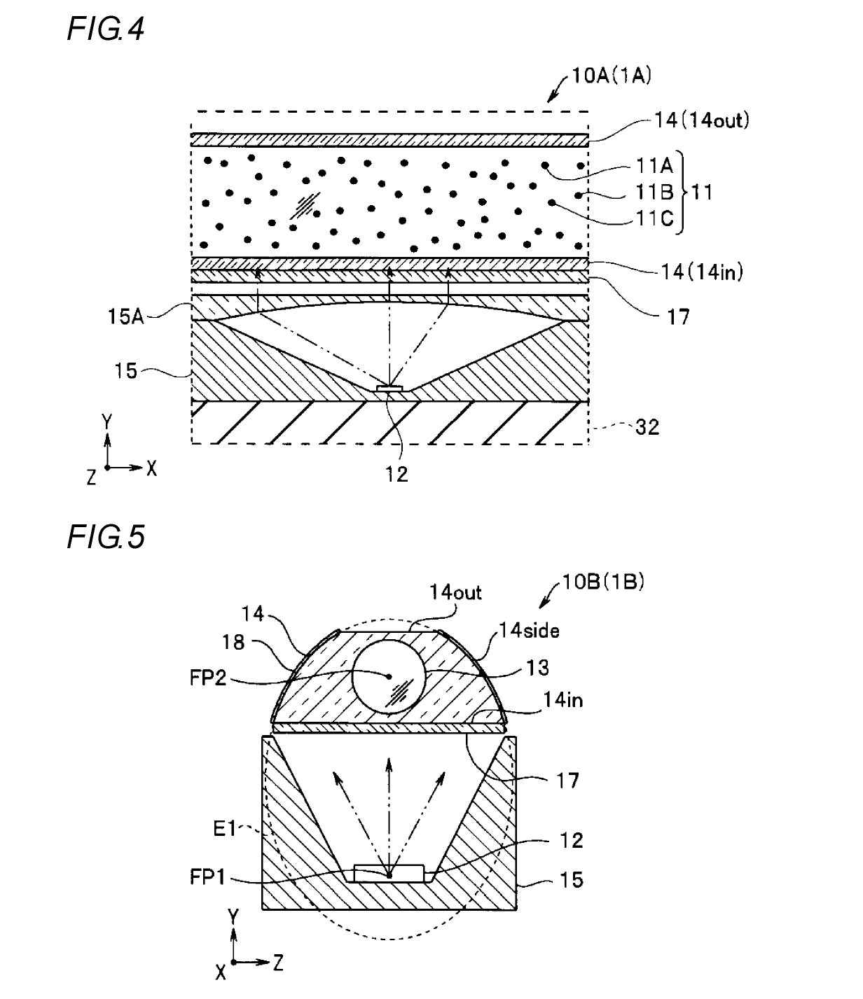

FIG. 4 is a cross-sectional view (XY plane) in a long-axis direction of the rod 14 of a light source device 10A of a modified example of the first embodiment. The light source device 10A further has a lens 15A that is an optical member that refracts the excited light generated by the light-emitting element 12 so that the direction of the light comes close to a vertical direction toward the incident part 14ᵢₙ.

The lens 15A is a concave lens where a peripheral part is thicker than the center is. A light emitted in such a direction that it may enter the dichroic coat 17 at a deep angle is more largely refracted by the lens 15A and enters the dichroic coat 17 at an angle close to a vertical direction.

Since the light source device 10A has an advantage of the light source device 10 and further the excited light enters the dichroic coat 17 at a large angle, the light source device 10A can emit a light more efficiently and thus a display device 1A comprising the light source device 10A can easily obtain a bright display picture.

Incidentally, FIG. 4 is a cross-sectional view in a long-axis direction but the reflection part 15/lens 15A preferably reflects/refracts the excited light so that the direction of the excited light comes close to a vertical direction toward the incident part 14ᵢₙ, also in a short-axis direction. Moreover, instead of the reflection part 15 and the lens 15A, a grating element or the like that changes the light path direction by a diffraction effect may be used.

### Second Embodiment

A light source device 10B of the second embodiment and a display device 1B comprising the light source device 10B is similar to the light source device 10 or the like, so that the same reference numeral or sign is attached to the same constitutional element and explanation thereof is omitted.

As shown in FIG. 5, a rod 14B of the light source device 10B has a smaller size of cross-section of the hollow part than the rod 14 of the light source device 10 has. In other words, the amount of the light-converting member 13 used is small.

Further, the light source device 10B has a reflection part (first reflection part) 18 that reflects the excited light entering around the outgoing part 14ₒᵤₜ, through a transparent part of the rod 14. The reflection part 18 is, for example, disposed by vapor deposition of a metal film on the rod 14.

The cross-sectional shape of the reflection part 18 in a short axis direction is a part of the arc of first ellipse E1. The light-emitting element 12 is disposed at first focal point FP1 of the first ellipse E1 and the light-converting member 13 is disposed at second focal point FP2 of the first ellipse E1.

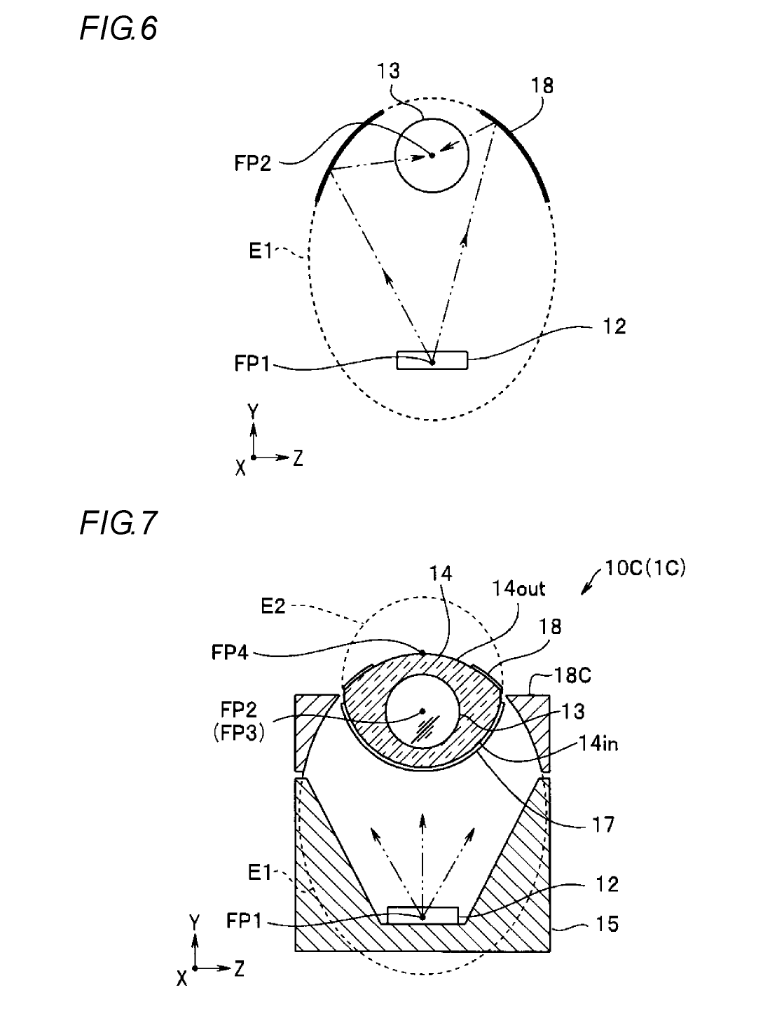

When a light emitted from first focal point of an ellipse is reflected by the arc of the ellipse, the light is condensed to second focal point. Therefore, as shown in FIG. 6, of the excited light emitted by the light-emitting element 12, a light reflected by the reflection part 18 is surely guided to the light-converting member 13. Incidentally, the cross-sectional shape of the outgoing part 14ₒᵤₜ may be not a straight line (plane) but a part of the arc of the first ellipse E1.

The light source device 10B can efficiently irradiate a small light-converting member 13 with the excited light. Thus, the light-converting member 13 comprising the quantum dot 11 is not inexpensive but the light source device 10B (display device 1B) can be produced inexpensively as compared with the light source device 10 (display device 1).

### Third Embodiment

A light source device 10C of the third embodiment and a display device 1C comprising the light source device 10C are similar to the light source device 10B and the like, so that the same reference numeral or sign is attached to the same constitutional element and explanation thereof is omitted.

As shown in FIG. 7, in the light source device 10C, in addition to the constitution of the light source device 10B, the cross-sectional shape of the incident part 14ᵢₙ of a rod 14C in a short-axis direction is a part of the arc of second ellipse E2, about the center of the light-converting member 13 is disposed at first focal point FP3 of the second ellipse E2, and an outgoing part 14ₒᵤₜ is disposed on second focal point FP4 side of the second ellipse E2. Namely, the second focal point FP2 of the first ellipse E1 and the first focal point FP3 of the second ellipse E2 are present in the same position.

As already explained, the incident part 14ᵢₙ of the rod 14C is covered with the dichroic coat 17.

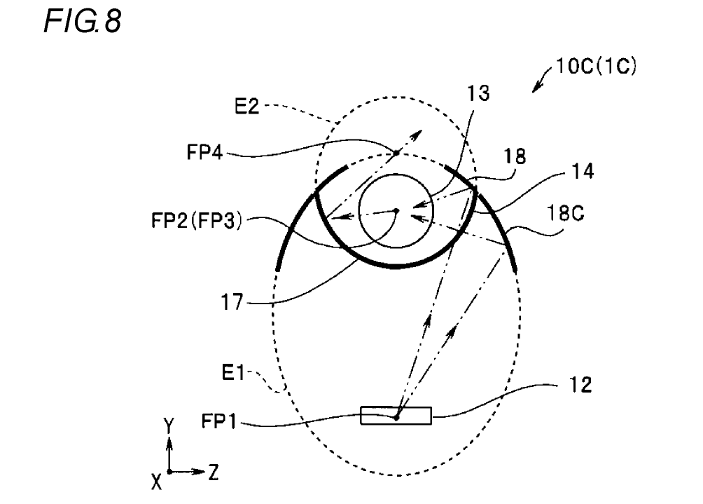

Therefore, as shown in FIG. 8, of the long-wavelength light emitted by the first focal point FP3 of the second ellipse E2, a light reflected by the dichroic coat 17 is surely guided to second focal point FP4 on the outgoing part side. Incidentally, the outer peripheral part of the light-converting member 13 may be disposed at the first focal point FP3 of the second ellipse E2.

In FIG. 8, the second focal point FP4 is coincident with the outgoing part 14ₒᵤₜ but the position of the second focal point FP4 may be sufficiently set so that a light passing through the second focal point FP4 enters through an end surface of the light guide plate 20. Moreover, the cross-sectional shape of the outgoing part 14ₒᵤₜ may be a straight line or the like.

The light source device 10C has an advantage of the light source device 10B and further, of the long-wavelength light, a light reflected by the dichroic coat 17 enters the light guide plate 20 without multiple reflection, so that a white light having good color rendering properties can be efficiently generated.

Furthermore, the light source device 10C has a reflection part (second reflection part) 18C having a reflection surface at a part of the arc of the first ellipse E1 on the extension of the reflection part (first reflection part). Namely, the reflection surface of the reflection part 18 is a part of the arc of the first ellipse E1. Incidentally, the reflection part 18C may sufficiently have a high reflectivity at least on a surface at which the excited light enters.

Of the excited light emitted by the light-emitting element 12, a light reflected by the reflection part 18C is surely guided to the light-converting member 13. Namely, the light source device having the reflection part 18C can more efficiently irradiate the light-converting member 13 with the excited light.

While some embodiments of the invention has been described but these embodiments are presented as examples and it is not intended to restrict the scope of the invention. These novel embodiments can be carried out in various other forms, and various omissions, replacements, and changes can be made therein within a range without departing from the gist of the invention. These embodiments and modifications thereof are included in the scope and gist of the invention and also included in the inventions described in Claims and equivalent ranges thereof.

1. A light source device comprising:
a light-emitting element configured to emit an excited light comprising a wavelength shorter than that of a blue light and
a rod comprising a first opening defining an entry area and a second opening defining an exit area, the rod also comprising a light-converting material enclosed inside the rod, the rod emitting a white light from the exit area of the rod, and the light-converting material converting the excited light that enters through the entry area of the rod into a long-wavelength light comprising a longer wavelength,
wherein the entry area is covered with a dichroic coat that transmits the excited light and reflects the long-wavelength light,
the light source device further comprises an optical material that reflects or refracts the excited light generated by the light-emitting element so that a direction of the excited light is substantially vertical toward the entry area and a reflection part that reflects the excited light,
wherein a cross-sectional shape of the reflection part is a part of an arc of a first ellipse and a cross-sectional shape of the entry area is a part of an arc of a second ellipse,
wherein the light emitting element is disposed at a first focal point of the first ellipse,
wherein the light-converting material is disposed at a second focal point of the first ellipse and at a first focal point of the second ellipse, and
wherein the outgoing part is disposed on a side of a second focal point of the second ellipse.

2. A light source device comprising:
a light-emitting element configured to emit an excited light comprising a wavelength shorter than that of a blue light and
a rod comprising a light-converting material enclosed inside the rod, the rod emitting a white light from an outgoing part, and the light-converting material converting the excited light that enters through an incident part into a long-wavelength light comprising a longer wavelength,
wherein the incident part is covered with a dichroic coat that transmits the excited light and reflects the long-wavelength light.

3. The light source device according to claim 2, wherein the light-converting material comprises a quantum dot that converts the excited light into the long-wavelength light.

4. The light source device according to claim 3, which further comprises an optical material that reflects or refracts the excited light generated by the light-emitting element so that the direction of the excited light is substantially vertical toward the incident part.

5. The light source device according to claim 4,
which further comprises a reflection part that reflects the excited light
wherein the cross-sectional shape of the reflection part is a part of an arc of a first ellipse,
wherein the light emitting element is disposed at a first focal point of the first ellipse, and
wherein the light-converting material is disposed at a second focal point of the first ellipse.

6. The light source device according to claim 5,
wherein the cross-sectional shape of the incident part is a part of an arc of a second ellipse,
wherein the light-converting material is disposed at a first focal point of the second ellipse, and
wherein the outgoing part is disposed on a side of a second focal point of the second ellipse.

7. A light source device comprising:
a light-emitting element configured to emit an excited light comprising a wavelength shorter than that of a blue light and
a rod comprising a light-converting material enclosed inside the rod, the rod emitting a white light from an outgoing part, the light-converting material converting the excited light that enters through an incident part into a long-wavelength light comprising a longer wavelength,
wherein a cross-sectional shape of a reflection part that reflects the excited light is a part of an arc of a first ellipse,
wherein the light emitting element is disposed at a first focal point of the first ellipse, and
wherein the light-converting material is disposed at a second focal point of the first ellipse.

8. A display device comprising:
a light source device according to claim 1,
a light guide plate whose end surface opposes the outgoing part of the light source device, and
a liquid crystal display part disposed on a main surface side of the light guide plate.

9. A display device comprising:
a light source device according to claim 2,
a light guide plate whose end surface opposes the outgoing part of the light source device, and
a liquid crystal display part disposed on a main surface side of the light guide plate.

10. A display device comprising:
a light source device according to claim 3,
a light guide plate whose end surface opposes the outgoing part of the light source device, and
a liquid crystal display part disposed on a main surface side of the light guide plate.

11. A display device comprising:
a light source device according to claim 4,
a light guide plate whose end surface opposes the outgoing part of the light source device, and
a liquid crystal display part disposed on a main surface side of the light guide plate.

12. A display device comprising:
a light source device according to claim 5,
a light guide plate whose end surface opposes the outgoing part of the light source device, and
a liquid crystal display part disposed on a main surface side of the light guide plate.

13. A display device comprising:
a light source device according to claim 6,
a light guide plate whose end surface opposes the outgoing part of the light source device, and
a liquid crystal display part disposed on a main surface side of the light guide plate.

14. A display device comprising:
a light source device according to claim 7,
a light guide plate whose end surface opposes the outgoing part of the light source device, and
a liquid crystal display part disposed on a main surface side of the light guide plate.
